(19) United States
(12) Patent Application Publication
(10) Pub. No.: US 2012/0078417 A1
(43) Pub. Date: Mar. 29, 2012

(54) Detecting Energy and Environmental Leaks In Indoor Environments Using a Mobile Robot

(75) Inventors: Jonathan Hudson Connell, II, Cortlandt Manor, NY (US); Rajarshi Das, New Rochelle, NY (US); Hendrik F. Hamann, Yorktown Heights, NY (US); Canturk Isci, West New York, NJ (US); Jeffrey Owen Kephart, Cortlandt Manor, NY (US); Levente Ioan Klein, Tuckahoe, NY (US); Jonathan Lenchner, North Salem, NY (US); Michael Alan Schappert, Wappingers Falls, NY (US)

(73) Assignee: International Business Machines Corporartion, Armonk, NY (US)

(21) Appl. No.: 12/892,532

(22) Filed: Sep. 28, 2010

(51) Int. Cl. B25J 9/00

(52) U.S. Cl. 700/248; 700/258; 901/1

(57) ABSTRACT

Techniques for energy and environmental leak detection in an indoor environment using one or more mobile robots are provided. An energy leak detection system is provided. The energy leak detection system includes one or more mobile robots configured to move throughout at least a portion of a building and to take temperature and air flow measurements at a plurality of locations within the building. An environmental leak detection system is also provided. The environmental leak detection system includes one or more mobile robots configured to move throughout at least a portion of a building and to take airborne matter measurements at a plurality of locations within the building.

### FIELD OF THE INVENTION

The present invention relates to energy and environmental leak detection, and more particularly, to techniques for energy and environmental leak detection in an indoor environment, e.g., a building, using one or more mobile robots.

### BACKGROUND OF THE INVENTION

Buildings typically lose energy in a variety of ways, such as (i) via unintended pathways of air from the indoor to outdoor environments, with a consequent unintended net influx or outflux of air from the indoor environment, (ii) via over- or under-provisioned, and sub-optimally arranged targeted cooling and heating solutions, and (iii) by the existence of unintended thermal barriers. Inefficient insulation, for example, can act as in case (i) by allowing for an unintended influx/outflux of air, but can also act, as in case (iii), as an unintended thermal barrier.

In recent years, with the increasing cost of energy, initiatives aimed at the active management of energy and attempts to improve the energy efficiency of all sorts of buildings and facilities have gained tremendous momentum. For example, at the data center and enterprise information technology (IT) level, the increased cost of energy has led to a renewed interest in active monitoring and control of energy consumption and cooling efficiency via asset management and physical monitoring technologies (e.g. International Business Machines Corporation (IBM) Tivoli Monitoring for Energy Management (ITMfEM) and Maximo Asset Management for Energy Optimization (MAMEO)). At the residential level, energy audits have started to become popular with home-owners. The U.S. Department of Energy provides information for home-owners interested in doing their own home energy audit, or for those interested in hiring a professional contractor to conduct such an audit.

The techniques employed to solve the problem of energy leak detection at the enterprise IT level include, for example, the use of heat and air flow sensors statically placed throughout a space, the use of a mobile, human-operated, sensing station such as in Mobile Measurement Technology (MMT) and a combination of these approaches, such as in later versions of the MMT. See, e.g., H. Hamann et al., “Rapid Three-Dimensional Thermal Characterization of Large-Scale Computing Facilities,” IEEE Transactions on Components and Packaging Technologies, vol. 31, no. 2 (June 2008) and M. Iyengar et al., “Comparison between numerical and experimental temperature distributions in a small data center test cell,” Proceedings of IPACK2007.

The use of static sensors is, however, necessarily rather sparse in its spatial resolution since the sensors cannot be placed in certain areas without interfering with the normal operations of the data center which needs to support the relatively unencumbered movement of data center and server system administrators. Moreover, one cannot place a static sensor in mid-air without it being attached to a ceiling or some other fixed structure. The use of statically placed sensors can also be challenging because the sensors need to be kept powered-up if powered by battery, and moreover, if one suddenly needs to deploy a new type of sensor, a mass redeployment effort is required. The operation of a mobile, human-operated, sensing station solves these problems but is expensive due to the associated labor cost. Hence such an approach is typically only used to obtain baseline measurements for subsequent feeding into computational fluid dynamics (CFD) models, or occasionally thereafter, to verify that the current state of the data center (from an air-flow or CFD perspective) has not veered too far from the baseline. Thus, the use of a human-operated sensing station is necessarily sparse in its temporal resolution. The combined use of static sensors and a mobile sensing station is an improvement on either approach alone, but still requires the use of skilled personnel to do an initial data center (baseline) scan and to interpret combined readings from the baseline scan and subsequent scans from the static sensors.

The current residential approaches to energy management typically involve minimalistic energy audits. During such audits, inspectors/auditors often employ low-cost equipment such as infrared thermometers that simply collect narrow beams of reflected infrared radiation, and without calibrating for the differing emissivities of materials, estimate temperatures of target surfaces. A comparison can then be made, for example, of surface temperatures at places of suspected leaks to surface temperatures where leaks are not likely, such as along interior dividing walls. Alternatively, the auditor/inspector will go through a simple checklist of common sources of energy leaks such as the sealing around doors, the presence of single-paned, double-paned or low emissivity (“low-e”) windows, the degree of insulation in outside-facing walls, and so forth. Thus in the residential domain, the conventional techniques provide highly sparse information both spatially and temporally, with low accuracy and confidence. In addition, shape irregularities in the indoor environment such as the presence of bay windows in homes and over-hangs, add accessibility constraints that make use of the MMT-style mobile sensing station described earlier of limited practical value in these residential environments.

Environmental leaks, such as the flow of airborne contaminants, e.g., radon gas, can be extremely harmful to building occupants. Conventional tests for detecting such airborne contaminants are time-consuming, labor intensive and temporally sparse. In the case of radon for example, an inspector might be commissioned to test for the presence of the gas or its constituents at a few locations in the building once every few years (and in some instances only when the building is being sold). Thus the accuracy of such testing is questionable.

Therefore, techniques for detecting energy and environmental leaks that can obtain temporally and spatially dense readings, that do not require trained personnel to perform and are adaptable to a variety of different environments, including residential settings, would be desirable.

### SUMMARY OF THE INVENTION

The present invention provides techniques for energy and environmental leak detection in an indoor environment using one or more mobile robots. In one aspect of the invention, an energy leak detection system is provided. The energy leak detection system includes one or more mobile robots configured to move throughout at least a portion of a building and to take temperature and air flow measurements at a plurality of locations within the building.

In another aspect of the invention, a method for detecting energy leaks in a building is provided. The method includes the following steps. Temperature and air flow measurements are obtained from one or more mobile robots configured to move throughout at least a portion of the building and to take the temperature and air flow measurements at a plurality of locations within the building. A temperature and air flow model of the building is created using the temperature and air flow measurements. The model is used to identify energy leaks in the building.

In yet another aspect of the invention, an environmental leak detection system is provided. The environmental leak detection system includes one or more mobile robots configured to move throughout at least a portion of a building and to take airborne matter measurements at a plurality of locations within the building.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary system for detecting energy and/or environmental leaks in a building according to an embodiment of the present invention;

FIG. 2 is a diagram illustrating an exemplary mobile robot according to an embodiment of the present invention;

FIG. 3 is a diagram illustrating an exemplary methodology for detecting energy leaks and inefficiencies in a building according to an embodiment of the present invention;

FIG. 4 is a diagram illustrating an exemplary methodology for concurrent localization and heat/air flow/airborne matter mapping in a building having industry standard rectilinear tiles according to an embodiment of the present invention;

FIGS. 5A-B are diagrams illustrating an exemplary methodology based on the idea of onion-peeling that enables the integrated operation of two robots to gather layout and sensor data in approximately half the time of a single robot according to an embodiment of the present invention;

FIG. 6 is a diagram illustrating an exemplary methodology for detecting environmental leaks of airborne matter in a building according to an embodiment of the present invention; and

FIG. 7 is a diagram illustrating an exemplary computer apparatus which may be employed for detecting energy leaks and inefficiencies in a building according to an embodiment of the present invention.

### DETAILED DESCRIPTION OF PREFERRED EMBODIMENTS

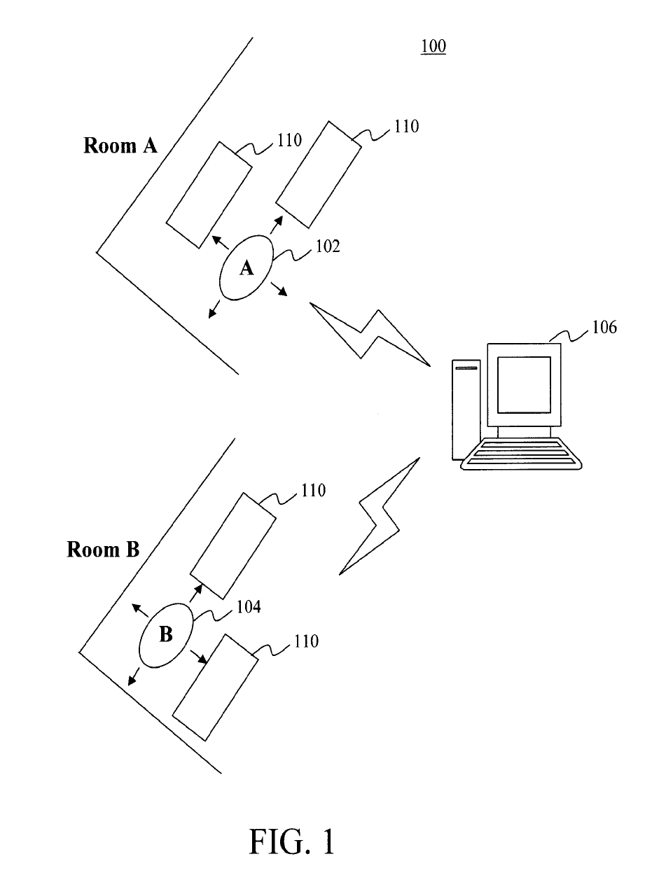

Provided herein are techniques for detecting sources of heating and air conditioning, i.e., “energy” leaks and inefficiencies, and for detecting airborne matter leaks in indoor environments, such as in buildings. For example, FIG. 1 is a diagram illustrating exemplary system 100 for detecting energy and/or environmental leaks in a building. The term “energy leak,” as used herein refers to an unintended change in the temperature of the indoor air as a result of flow either from the indoor environment out, or from the outdoor environment in. The term “environmental leak,” as used herein refers to the flux (influx or outflux) of airborne matter constituents in a building. By way of example only, the airborne matter may include airborne particulate (solid) matter, airborne gaseous matter and/or airborne liquid matter (e.g., humidity). The airborne matter constituents may be undesirable (for example in the case of an influx of radon gas) or desirable and intentionally produced (such as moisture to achieve a desired humidity in the building).

The term “building,” as used herein, is intended to refer to a variety of facilities, including, but not limited to, data centers hosting large amounts of information technology (IT) equipment, factories with highly energy consuming equipment, as well as industrial office space and residential family homes where typically the energy consumption per volume of occupied space is much less. The importance of the energy leak and inefficiency problem is clear in the case of data centers and factories by virtue of their energy utilization density. For example, data centers and factories often radiate large amounts of heat so cooling these facilities effectively is of paramount concern. However, the problem is also important in more general office buildings and residential family homes. In these facilities, unintended energy losses to the environment can be the single most expensive, controllable, energy cost.

In its most basic form, system 100 includes a single mobile robot 102 that is configured to move throughout one or more portions (i.e., a room(s), such as room A) of a building and take temperature, air flow and/or airborne matter measurements at a number of different locations to precisely pinpoint energy and/or environmental leaks in the building. In order to take temperature and air flow measurements, the robot is equipped with temperature and air flow sensors. As will be described in detail below, in accordance with a preferred embodiment, the temperature and air flow sensors are located on an automated telescoping mast to allow access, e.g., under overhanging obstacles. In order to take airborne matter measurements, the robot is equipped with one or more airborne matter sensors. As will be described in detail below, in accordance with a preferred embodiment, the airborne matter sensor or sensors is/are located on an automated telescoping mast to allow access, e.g., under overhanging obstacles. It is notable that in accordance with the present techniques, system 100 can be configured to detect energy leaks, environmental leaks, or both, and the sensor(s) employed can be tailored to the particular application.

The term “robot,” as used herein refers generally to any form of mobile electro-mechanical device that can be controlled by electronic or computer programming. In this basic form, as will be described in detail below, the single robot 102 will move throughout the designated portions of the building and take temperature, air flow and/or airborne matter measurements as well as time and positioning data (so as to permit the temperature, air flow and/or airborne matter data to be associated with a given position in the building at a particular time). The robot should be capable of moving in various directions along the floor of the building, so as to navigate where the robot needs to go and to maneuver around obstacles, such as equipment, furniture, walls, etc. (generically represented by blocks 110 in FIG. 1) in the building.

In this basic embodiment, the movements of the robot (throughout the building) are self-guided in the sense that the robot is configured to determine where to move (i.e., from one position to the next). In this example, the robot is also configured to determine when readings should be taken and/or potentially from which areas to sample. It is preferable that the robot in this example have the capability to collect and store the data, i.e., temperature, air flow and/or airborne matter measurements and time/positioning data, to allow for analysis at a later time.

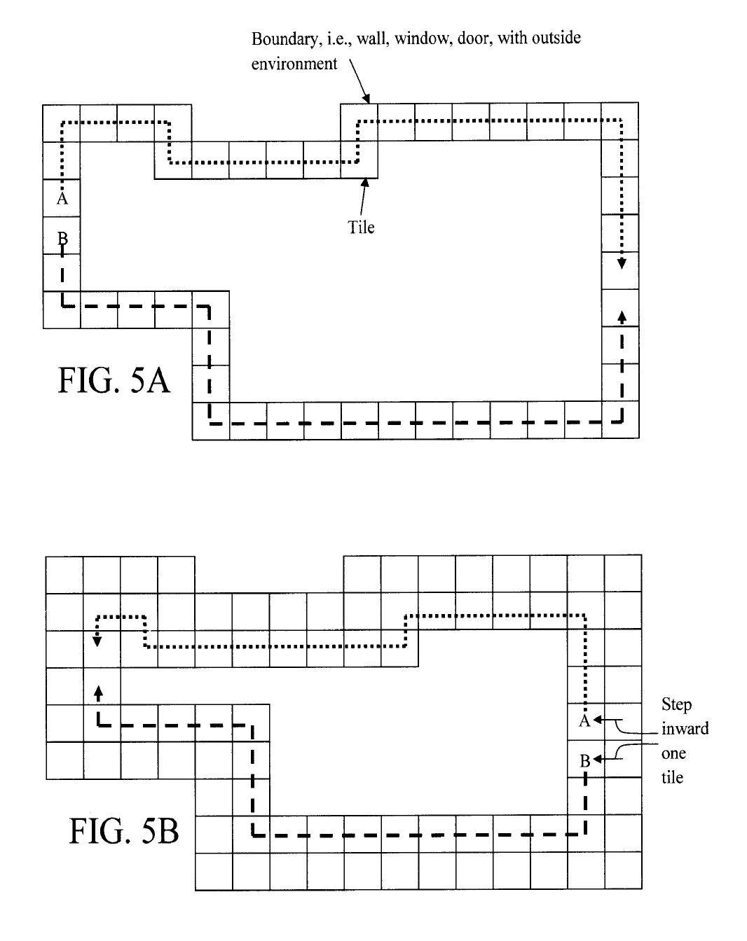

This basic embodiment can be expanded to include a system having more than one mobile robot, such as robot 104 (see FIG. 1). By way of example only, the additional robot(s) can be used to scan other rooms. This scenario is depicted in FIG. 1 where a robot A (robot 102) is used to take measurements in room A and a robot B (robot 104) is used to take measurements in room B. Employing, for example, two robots to perform a scan at the same time would cut the scan time in half as compared to using a single robot to scan room A and then room B. See the onion peeling scanning methodology described in conjunction with the description of FIGS. 5A-B, below, wherein two robots are used to scan a room. This time savings can also be seen by employing more robots, such as one robot per room. Another possible scenario is that the building contains multiple stories or floors and each robot or a group of robots is designated to a particular floor.

In other embodiments, system 100 further includes at least one computer 106. As indicated in FIG. 1, computer 106 is configured to communicate with robot 102 via a wireless connection which affords unrestricted movement of the robot throughout the building (however in some situations it may be possible and/or desirable to employ a wired connection (not shown) between the robot(s) and the computer). Computer 106 can be configured to receive the temperature, air flow and/or airborne matter measurements and time/location data from robot 102. Computer 106 may also be configured to control the movements of the robot. This feature is particularly useful when the system includes a plurality of mobile robots that are, for example, taking measurements from different locations within the building and/or of overlapping locations in the building but at different times (see below). However, computer 106 may be employed in the same manner when a single robot is being used.

As highlighted above, the movements of the robot can be self-guided. Alternatively, when the system includes a computer, the computer can control the movements of the robot(s). By way of example only, the computer can be configured to send location data to the robot(s) to guide the movements of the robot(s). Take for example a situation wherein two robots are being used to scan a single room (rather than one robot per room), and assume that in this instance it is not desirable for the robots to scan any of the same areas of the room as one another (although in some cases it might be desirable to do so), i.e., there is no overlap in the areas scanned by the two robots. See, for example, the description of FIGS. 5A-B, below. In this instance it might be desirable to employ computer 106 to coordinate and direct movement of the robots, so that positioning overlaps do not occur.

In yet other embodiments of the present techniques, a computer 106 is located on-board each of the robots. The computer in this manner can, in addition to coordinating movement of the robots, also perform analytic functions such as analyzing temperature, air flow and/or airborne matter data collected. Further, when multiple robots are used (and thus multiple computers 106 as well), the on-board computers can communicate and/or exchange data with one another, e.g., using conventional wireless transmissions.

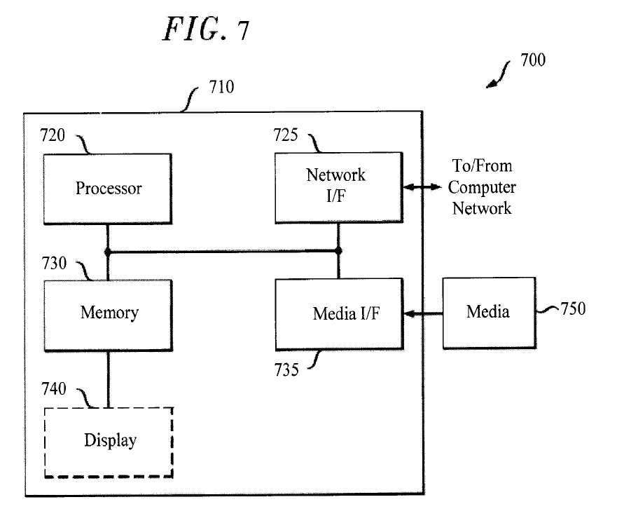

An exemplary apparatus that may serve as computer 106 is shown in FIG. 7, described below. This apparatus may be located central to the system (such as shown in FIG. 1) or on-board the robot(s).

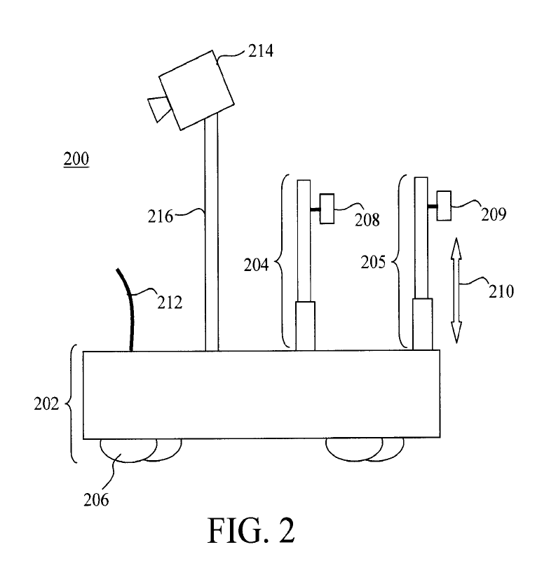

FIG. 2 is a diagram illustrating exemplary mobile robot 200. Robot 200 can be used in accordance with an energy leak detection system such as system 100 described in conjunction with the description of FIG. 1, above (i.e., robot 200 represents one possible configuration of robot 102 and/or robot 104 of system 100). According to the exemplary embodiment shown in FIG. 2, robot 200 includes a mobile robotic platform 202 and a plurality of masts, i.e., masts 204 and 205 (although the number of masts can vary, see below). Mobile robotic platform 202 is fitted with wheels 206 that permit movement of robot 200 in a variety of directions, e.g., along a building floor. A variety of different mobile robotic platform configurations suitable for use in conjunction with the present techniques would be apparent to one of skill in the art. For example, a customized mobile robotic platform may be used or, according to an exemplary embodiment, a commercially available mobile robotic platform (available, for example, from iRobot Corporation, Bedford, Mass. or from MobileRobots Inc., Amherst, N.H.) may be employed. A customized platform may, for example, contain components configured to guide/coordinate movement of the robot in a manner as described below.

Masts 204 and 205 preferably have telescoping capabilities (as shown in FIG. 2), the action of which is under control, e.g., of the robot (automated). Although, in its basic form non-telescoping masts could be employed. A telescoping mast is useful so that the robot can fit under and take reading from under overhanging obstacles. As indicated by arrow 210, masts 204 and 205 can be raised or lowered, as required. Techniques for configuring a telescoping mast so as to be under the control of the robot would be apparent to one of skill in the art, and thus is not described further herein.

Masts 204 and 205 each have one or more sensors attached thereto (shown generically in FIG. 2 as sensors 208 and 209, respectively). According to an exemplary embodiment, one of sensors 208 or 209 is a temperature sensor and the other of sensors 208 or 209 is an air flow sensor, which permit robot 200 to take both temperature and air flow measurements, respectively. FIG. 2 depicts one exemplary configuration of the robot wherein each mast supports a particular type of sensor. Thus, in FIG. 2 two masts support two types of sensors. This configuration is however merely exemplary, and other configurations are possible. By way of example only, a single mast could be used to support all of the sensors employed. Further, multiple sensors of the same type may be employed on the same, or on different masts.

Other types of sensors may also be employed in the same manner. By way of example only, an airborne matter sensor(s) can be used (in addition to, or in place of, the temperature and/or air flow sensors). Airborne contaminant detection is an important function in settings, such as hospitals, where radiation levels and levels of commonly occurring airborne contagions and other agents (e.g., mold, mildew and formaldehyde) are often monitored. Any suitable, commercially available or custom built sensors may be used.

As shown in FIG. 2, robot 200 can further include an antenna 212. Antenna 212 permits wireless communication (e.g., receive/exchange movement commands and/or data) with a computer and/or with one or more other robots commonly employed in a system, as described above and further below. It is notable however that an antenna is not essential for wireless communication.

Robot 200 may optionally further include on-board memory (not shown) for storing measurement data and time/location data. That way, as described above, the measurements taken by robot 200 can be linked to particular locations throughout the building. In this manner, the robot can transmit/transfer measurement data to the computer once a scan of the building (or a designated portion(s) thereof) has been completed.

According to an exemplary embodiment, the robot itself is capable of simultaneous localization and mapping (SLAM) by utilizing one or more of sonar, laser-range finding and video recognition. SLAM is a concept well known to those of skill in the art. In general, the basic SLAM problem asks if it is possible for a mobile robot to be placed at an unknown location in an unknown environment and incrementally build a consistent map of the environment while simultaneously determining its location within the map. The classical SLAM problem was articulated in the robotics community in the mid 1980s and the theoretical foundations for the solution of SLAM were laid out, for example, in H. Durrant-Whyte, D. Rye and E. Nebot, “Localization of Autonomous Guided Vehicles,” in G. Giralt and G. Hirzinger, editors, Robotics Research: The 7^{th} International Symposium on Robotics Research (ISRR 95), Springer-Verlag, 613-625 (1996). For an up-to-date treatment see, H. Durrant-Whyte and T. Bailey, “Simultaneous Localization and Mapping: Part 1,” IEEE Robotics and Automation Magazine 13:99-110 (2006) (hereinafter “Durrant-Whyte”). One of the key components of SLAM is the ability to establish landmarks which are subsequently re-recognized to help establish the robot's bearings. This landmark recognition can be performed by laser, video recognition or sonar, or even other methods. In a noisy space sonar is not a great choice, laser is sometimes only practical in a single plane, while video is time-consuming to process—so each approach has its advantages and disadvantages with the optimal choice being a function of the building type or particular building environment.

The advantages of using a robot as described herein versus, e.g., simply using an infrared thermometer (one of the most common methods employed by home and building inspectors) are that a robot can be much more fine-grained in its investigation than can an inspector with a thermometer. A robot can readily examine every “nook and cranny” of the perimeter or boundary of a set of rooms, even in a very large manufacturing floor, with a complicated and not easily accessible (to a human) perimeter. The perimeter or boundary of a room is typically where energy leaks occur since it is there that potential contacts with the outside environment occur. However, the robot may explore more than just the perimeter (boundary) of a room to discover precisely where the perimeter is, or to get around obstacles blocking a simple boundary traversal. Moreover, depending on the day, the temperature variation between outside and inside air may not be great. On such days it would be necessary to supplement the infrared thermometer (i.e., the infrared thermometer being used by a human inspector) with air flow sensors to detect a leak. This is because if there is not much of an inside/outside temperature differential, then the infrared thermometer readings alone may not be that helpful in detecting leaks. Thus, it would be advantageous to be able to supplement the temperature readings with air flow readings. Of course the advantages of using a robot as opposed to, for example, simply checking for common sources of leaks, are that some actual leaks may not be from a common source. Moreover, rules of thumb are sometimes not that applicable, and the conclusions drawn from them are not easy to quantify. Rules of thumb regarding energy leaks may be to add insulation, replace single-paned windows with double-paned windows, etc. but the impact and cost-effectiveness of these measures vary greatly. For example, single-paned windows will generally be fine if one has reasonable blinds, and the effect of changing to double-paned windows is highly dependent on the amount of sunlight the windows get (partially determined in turn by whether the windows are north or south facing (or neither) and at what latitude the home is. Similarly, the benefits of adding insulation versus fixing simple leaks is not easy to address by rules of thumb, but can be estimated with detailed air flow measurements and year-long computational fluid dynamics models. The robot has the ability to take precise measurements and thereby enable precise extrapolations regarding annual costs associated with any found energy leaks. In contrast to existing approaches for tracking energy efficiency in facilities, the proposed mobile robot-based solution provides better spatial and temporal resolution and significantly higher accessibility around a given facility layout.

According to an exemplary embodiment, the robot also has a vision component, e.g., camera 214 mounted on a mast 216. In the context of a regularly gridded (e.g., tiled) room such as a data center, the vision component of the robot is responsible for detecting a “pose” of the robot with respect to the center of a tile, and for determining whether the next tile which the robot wishes to investigate is visitable or blocked (for example because the tile is occupied by equipment or otherwise obstructed). Accordingly, as shown in FIG. 2, camera 214 is pointing at about a 30 degree angle from the horizontal. The pose of the robot is the location and orientation of the robot relative to the forward pointing “orthogonal” orientation at the center of the tile. The forward pointing orthogonal orientation is the orientation that is exactly aligned with the intended reckoning of the robot (from the center of one tile to the center of a second adjacent tile) such that if the robot moved straight ahead it would cross the boundary between the tiles along a path which is perpendicular (orthogonal) to the tile boundary and reach the center of the second tile in which it either intends to get to or intends to inspect, with the purpose of determining whether the second tile is visitable. This assumes that a (theoretical) straight line connecting the centers of two adjacent tiles is perpendicular (orthogonal) to the boundary between the two tiles, which is typically the case in data centers. See, for example, FIGS. 5A-B, described below.

In the data center context, the vision component specializes in detecting tile boundaries, determining a distance of the robot from a tile boundary (and thereby, a distance of the robot from the center of the tile), determining an angle the robot currently makes with the line orthogonal to the next tile boundary, and determining whether the next tile in the direction the robot is headed is occupied or visitable. According to an exemplary embodiment, the robot automatically determines, e.g., tile boundaries and whether a tile is visitable or obstructed. The programming of the robot to perform this task would be apparent to one of skill in the art and thus is not described further herein. For orientation purposes, the robot has a forward-pointing direction determined by the direction in which the vision component, e.g., camera, faces. This forward-pointing direction is also aligned with a forward wheel direction when the robot is instructed to move forward (i.e., when the robot rotates, it is not just the wheels that rotate but the entire assembly).

Many types of off the shelf web video cameras (a.k.a. webcams) are suitable for use as the vision component. When using a video camera, the robot can, for example, analyze an extracted sampling of still shots. Thus, it is also possible to use non-video capable web cameras.

The mounting location of the vision component (e.g., camera) on the robot can be varied. By way of example only, in FIG. 2, camera 214 is mounted on mast 216. Some general considerations about the mounting location of the vision component are notable. The vision component (e.g., camera) needs to be high enough so that the vision component can obtain an image of at least a large fraction of the next tile from the center of a current tile (in which the robot resides). However, mounting the vision component (e.g., camera) too high can also be problematic. For example, mounting the vision component on too tall a mast can make the robot unstable.

In a more general facility where there is no guarantee of a gridded layout of tiles, one option is to lay down a fine rectangular grid (e.g., a grid with cell dimensions of 6 inches by 6 inches) of alpha or beta emitting particles to simulate tiles and subsequently (upon backtracking) have the robot detect the grid of alpha or beta emitting particles using methods akin to those used with a mounted webcam. While a webcam by itself would not be able to detect alpha or beta particles, once the location of the alpha or beta particles are known (e.g., using an alpha or beta detector such as a thin-film Geiger-Muller Counter), the webcam could take a snapshot of the vicinity around the alpha or beta particles and the robot could keep a record of the square determined by the alpha or beta particles and the surroundings, so that next time the robot could do a reasonable job of navigating back.

This artificially placed grid, i.e., virtual tiles, can serve to mark where the robot has been and to keep track of, for example, a depth-first search tree on the virtual tiles, to ensure a complete navigation of the environment, if that is desirable. A depth-first search tree is a software data structure that keeps track of an attempted complete exploration of a graph. In the case of these virtual tiles, the nodes of the graph are the virtual tiles and in one implementation of the depth first search tree, two tiles are connected by an edge of the graph if they are neighbors in the tile layout—in other words if the robot can travel from tile1 to tile2 without passing through additional tiles.

To provide free movement throughout the building, in one exemplary embodiment robot 200 runs on battery power. Preferably, the battery is rechargeable and the system further includes one or more charging stations (not shown). That way, if the robot runs low on power during a scan, the robot can proceed to the charging station, recharge and then resume the scan at the last location visited (see below). Techniques for configuring a mobile robot to return to a charging station to recharge are known to those of skill in the art and thus are not described further herein.

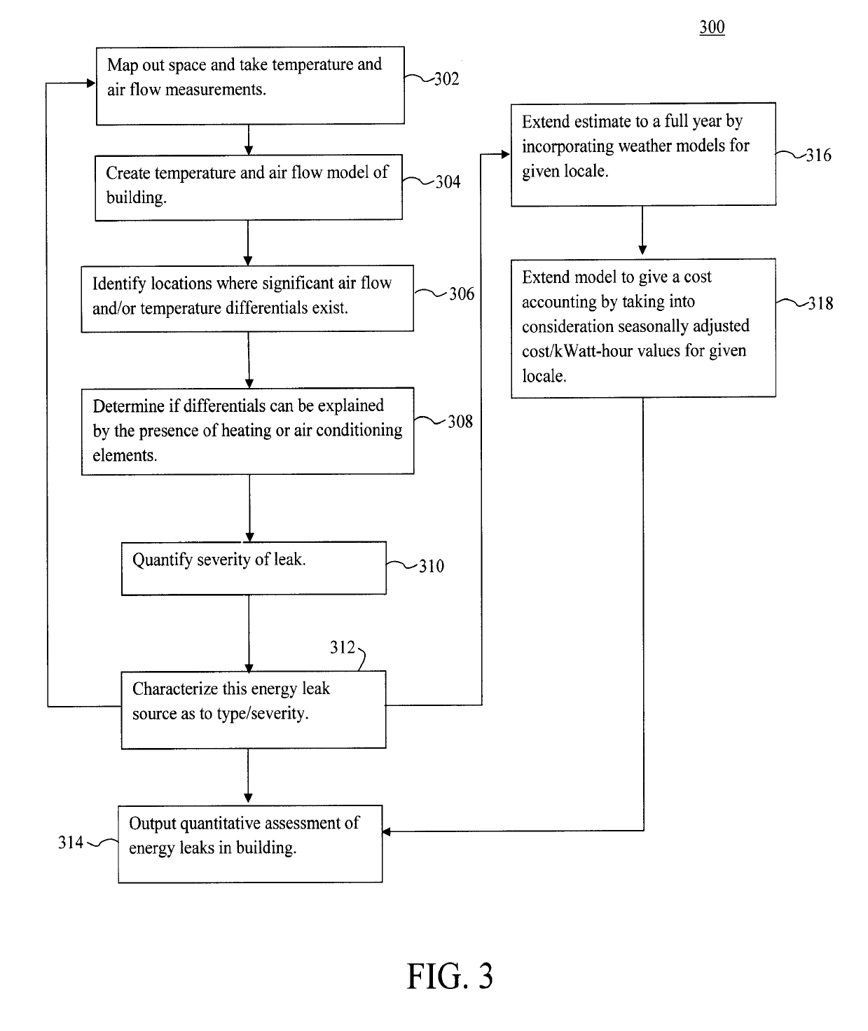

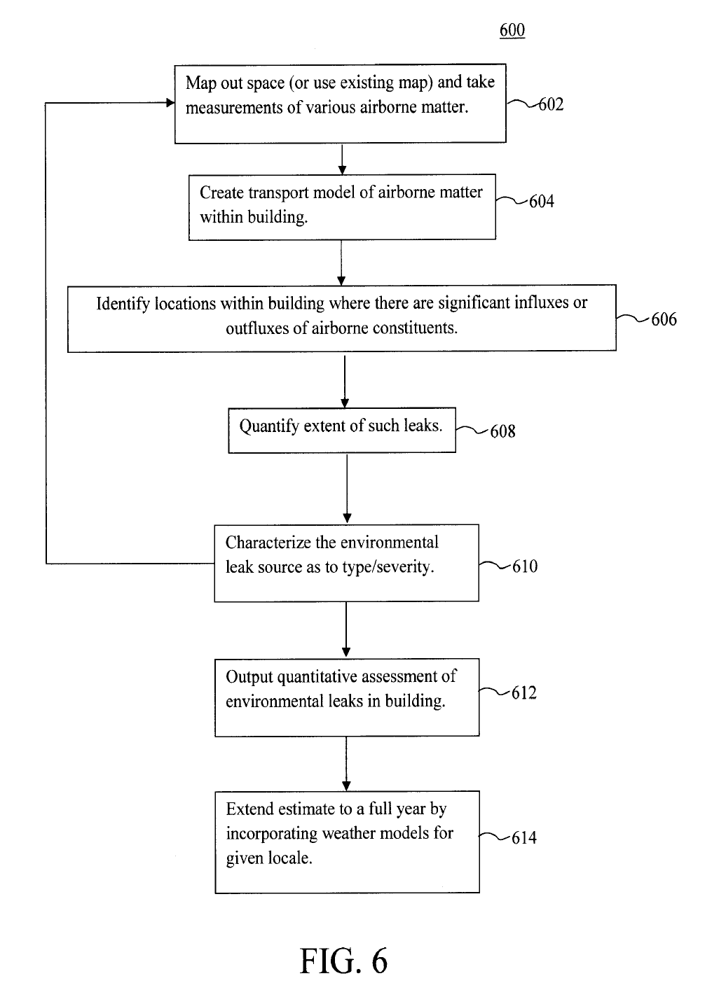

FIG. 3 is a diagram illustrating exemplary methodology 300 for detecting energy leaks in a building. Methodology 300 will be described in the context of an energy leak detection system (which, as described above, may optionally be an environmental leak detection system as well), such as system 100 described in conjunction with the description of FIG. 1, above, having one or more mobile robots configured to take temperature and air flow measurements throughout the building. It is notable that temperature and air flow parameters are being used here as an example. Other values such as airborne contaminant concentrations can also be measured. FIG. 6, described below, illustrates an exemplary methodology for detecting environmental leaks of airborne matter (as opposed to energy).

Each step of methodology 300 can be performed by a computer (for example computer 106 of FIG. 1, described above). The computer, as highlighted above, can be a centralized unit of the system and/or localized on-board the robot(s). Thus, with regard to the description of methodology 300, reference is made generically to actions performed by the system with the understanding that these actions can be performed by a centralized computer and/or by a computer(s) localized on-board the robot(s).

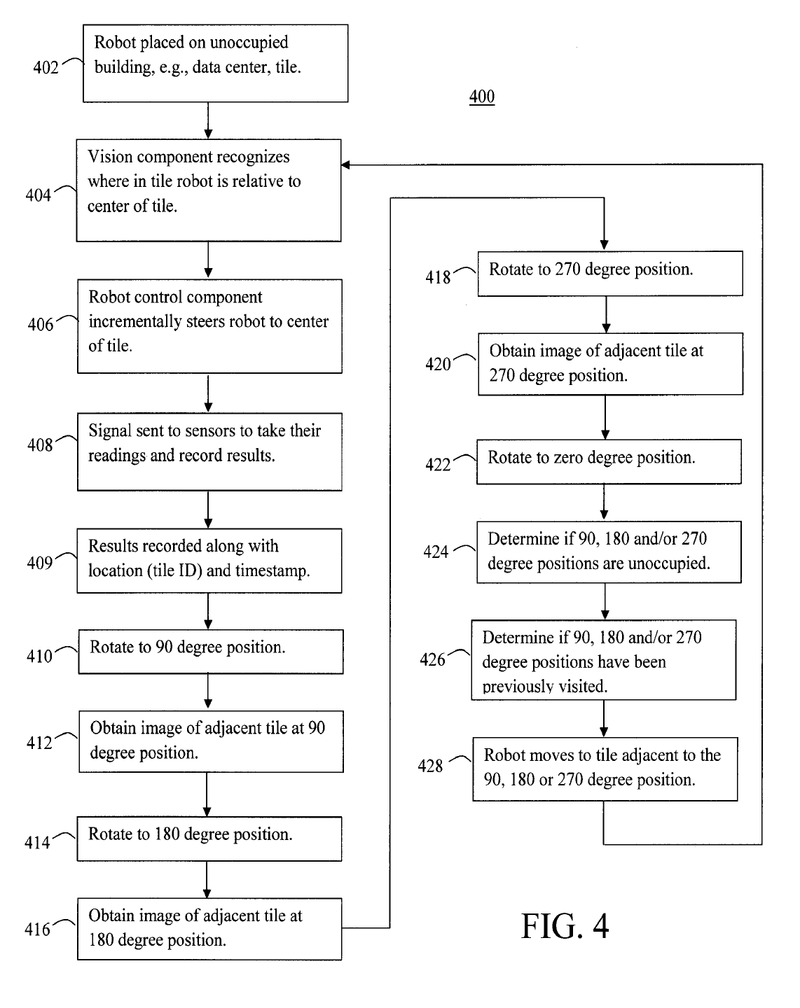

In step 302, the energy leak detection system is used to map out a space, i.e., within the building, and concurrently take temperature and air flow measurements as well as time and positioning data. With regard to time, an assumption is made that the temperature measurements gathered in one sampling run by the robot(s) are sufficiently close in time to be considered concurrent (in other words the outdoor air temperature does not vary significantly during the course of the scan by the robot(s)). The space is generally the building or a part thereof. According to an exemplary embodiment, the space referred to herein is a space proximate to a boundary to the outside environment. By way of example only, the space could be the interior area of the building proximate to the boundary of the building (i.e., walls, doors and/or windows that separate the interior of the building from the outside environment). See, for example, FIGS. 5A-B (described below), wherein the one or two layers of tiles shown may be considered the interior area of the building proximate to the boundary. In this example, it is likely unnecessary to map out the entire building or facility since there are no energy losses in the interior of the building. An exemplary methodology for “mapping out” a space and taking temperature and air flow measurements using the present energy leak detection system with one or more mobile robots will be described, for example, in conjunction with the description of FIG. 4, below. The term “map out,” as used herein, broadly refers to building/creating a map of the space simultaneously with the coordinated movement of the robot(s) from one location in the space to another (using for example a given grid or a superimposed grid to aid in navigation based on Simultaneous Localization and Mapping (SLAM) techniques). See description below. In this manner, the map can be built expeditiously.

In step 304, the temperature and air flow data collected at each location (from the mapping and measurement performed in step 302) are used to create a temperature and air flow model of the space. A number of different temperature and air flow models could be created using the data, and the type of model chosen can vary depending, e.g., on how the data is to be analyzed. Techniques that can be used to create a temperature and air flow model from such data, and what particular type of model to create would be apparent to one of skill in the art and thus are not described further herein. According to an exemplary embodiment, the model created is a three-dimensional thermofluidic model (i.e., a model that incorporates the flow of air and the spatio-temporal evolution of temperature. The spatio-temporal evolution of temperature is a representation of the spatial distribution of the temperature throughout the facility over time.

In step 306, the temperature and air flow model is used to detect energy leaks, i.e., identify locations in the building where significant air flow and/or temperature differentials exist. There is some natural variation of temperature in a building. Thus, in this case, (1) what is being sought is variation that is outside of the normal variation (this can be determined statistically using confidence intervals), (2) what is being sought is a variation, the direction of which, would be indicative of a leak; in summer this would mean a higher temperature along an outside boundary than along an inside wall; in winter this would mean the reverse, and (3) the difference must translate into a cost such that remediating the situation would have some reasonable return on investment (as determined by the home or building owner). One way to identify such locations and make this notion of “significant differentials” more concrete is to partition the space, in this case the space proximate to a boundary to the outside environment (see above), into a set of non-overlapping regions of equal volume and boundary surface area. This can be done almost arbitrarily—it is like dicing up the region near the outer surface of a rectangular solid into equal volumes while keeping the surface area of each region equal, and moreover, so that the union of the surface areas of the regions completely covers the surface area of the solid. One consideration is to keep the patches of surface area small enough so that one is not likely to capture leaks from two sources within the one region. According to an exemplary embodiment, the regions are chosen to be small enough that the air flow/temperature differentials across a given region, if present, can be attributable to a single source (see below). The model is then used to determine the air flow and temperature gradient across each region to then estimate energy losses. Neighboring regions can then be aggregated and regions ranked according to energy loss per unit amount of surface area to get the most significant regions of loss (in ranked order). This step of aggregating and ranking the regions is an optional step. The regions may be small and moreover one will typically find that several neighboring regions all have comparable temperature and air flow differentials. One can then infer that the regions are associated with a common energy leak source. This is the same process a home energy auditor using an infrared thermometer would go through, however with a robot one simply gets more detailed and more uniformly sampled data.

However, not all significant air flow and/or temperature differentials should be considered to be energy leaks. By way of example only, heating and/or air conditioning elements are intended to purposely introduce air flow and/or temperature differentials into the space, and should not be considered as energy leak sources in this analysis. Therefore, in step 308, a determination is made as to whether the air flow and/or temperature differentials at any of the locations identified in step 306 can be explained by the presence of heating and/or air conditioning elements, so as to eliminate these locations from the analysis.

Thus, the system needs to be able to recognize and distinguish temperature and air flow gradients encountered, for example, at baseboard heating and/or at other heating/air conditioning vents from those occurring due to unintended sources of energy leaks. A vent, for example, might produce a more regular temperature and/or air flow pattern in the model as compared to a crack in a wall (an unintended energy leak source) allowing the system to distinguish between the two.

In step 310, for all unintended energy leak sources the system quantifies the severity of the leak. The severity of the leak can be determined using representative air flow measurements at various points within each region (from step 306) and using these measurements to get an approximate air flow across each region. A temperature differential between the air in each region and an average indoor air temperature is then determined. The air flow and temperature differential values can be used to compute the approximate number of joules lost to the environment due to the leak within that region. Neighboring regions with approximately the same air flow and temperature characteristics can be assumed to be attributable to the same source. Accordingly, the energy leak contribution (air flow/temperature differentials) of these regions can be summed to get the total leak attributable to the given source. However, not all regions would experience air flow/temperature differentials attributable to a leak, and one is only concerned with regions of substantial air flow or temperature differential (as described above).

Although the above description focuses on energy leaks to the outside environment, similar techniques can be used to detect unintended no-air flow areas that sometimes occur in the interior of buildings with deleterious effects to the occupants. One can compute average room-to-room flow and pinpoint areas of low flow by taking air flow and/or temperature readings and applying the same techniques where now exceptionally low flow is indicative of a problem rather than the reverse.

In step 312, each energy leak (from step 310) is characterized by the type of its source. Namely, based on experience with different facilities using machine learning techniques, or by prior background knowledge input into the system (for example from a database of known leak types and severities), the system may be configured to specify the likely source of the energy leak, such as poor quality insulation, unevenly spread or bunched-up insulation or unexpected air passageways through for example cracks. These categories of energy leak sources are also referred to herein as “types,” i.e., the system “types” the energy leak source as, e.g., poor quality insulation.

As shown in FIG. 3, steps 302-312 can be repeated. By way of example only, if a single scan of the building (representing for example one point in time) is desired, then steps 302-312 would be performed once and a quantitative assessment of energy leaks in the building can be performed (see description of step 314, below). If, however, multiple scans of the building are desired, for example, to be performed at several different times throughout the year, then steps 302-312 could be repeated for example at a given time interval (such as once a month). Then, once data has been collected for a desired time period, e.g., for 6 months or a year, the quantitative assessment of energy leaks in the building can be performed.

Having performed either a single scan, or several periodic scans over the course of a representative time interval, in step 314, a quantitative assessment of energy leaks is produced, which is an estimate of the amount of energy loss based on in-building measurements for a single point or aggregation of points in time. For a given scan, this quantitative assessment includes the energy losses per region which are summed for all of the regions to come up with a total number of joules lost to the outside environment based on measurements that were taken at that singular moment or collective moments in time.

In step 316, the data collected by the system from a single scan, or from multiple scans, can optionally be combined with information about seasonal temperature distributions to extend the energy leak analysis over an extended period of time, e.g., over the course of a year. By way of example only, the scan data can be combined with data from a yearly weather model for a given locale (e.g., the city/town in which the building is located) and then the quantitative assessment (of step 314) can be performed using this combined data. In this example, the result will be an estimated energy leak analysis for the building over the period of a year. If just a single point-in-time scan has been performed, the differentials between the ambient outside air temperature for the given locale and the temperatures at the various energy leak sources are used to extrapolate to analogous differentials for days of differing outside air temperatures, using a knowledge of the distribution of degree days for the given locale (i.e., the number of days when the mean outside temperature (t outside) differs from room temperature (t_room) by various amounts). For example, it may be that |t_outside−t_room|>5 degrees F. for 250 days,|t_outside−t_room|>10 degrees F. for 150 days,|t_outside −t_room|>15 degrees F. for 50 days, etc. If actual representative measurements for the given locale have been taken at various times during the year, these temporally finer measurements will allow more precise extrapolations. Any standard statistical method for extrapolating or estimating temperatures based on these scans may be used, the selection and implementation of which would be apparent to one of skill in the art. From the distribution of temperature differentials and the degree days distribution for the locale, the energy losses for each day (for the entire facility) may be estimated, and then summed over the desired period (e.g., over a year) to get total energy loss estimates for the period.

Further, optionally, in step 318, the energy leak analysis can be expanded to include a cost analysis, for example, of annualized costs associated with heating and/or air conditioning unnecessary volumes of air. By way of example only, the analysis data can be translated into monetary costs if, e.g., seasonally adjusted cost per kilowatt hour data are provided. This cost information is of course specific to a given locale and is easily obtainable. Using a simple example, if in step 310 the estimated joules/minute loss for a given source is 60,000 and the cost of energy per kilowatt hour for the locale is $0.12, then the cost impact of that particular energy leak is $0.12/hour, which could result in an annual cost savings of $1051.20 alone if that particular energy leak is rectified. This savings multiplied by the number of energy leaks detected could be extremely significant. Further, seasonally or time-of-day adjusted values, if available, can be figured into the cost analysis. Thus if a scan is done that estimates a total energy loss of $X/day for a day in which the number of degrees between the outside temperature and thermostatic set point for heating or cooling is Y degrees, but the average differential for the given locale is Z degrees, then one can estimate the average daily energy loss to be $X*(Y/Z). Of course, this is just a rough estimate, greater temperature differentials will in general result in somewhat greater than proportional energy losses.

Techniques that may be employed in accordance with the present teachings to coordinate movement of the robot(s) around the building while at the same time scan for energy leaks (also referred to herein as “concurrent localization and heat/air flow mapping”) will now be described. In a data center, for example, coordinating movement of the robot(s) is facilitated somewhat by the fact that the typical data center floor consists entirely of industry-standard two foot by two foot tiles. In this case, the localization of the robot can be accomplished using video means, as long as still pictures (provided by the robot (see above) of the floor) can be accurately analyzed and tile boundaries thereby determined. By way of example only, the computer (i.e., computer 106—possibly an onboard computer) or a human operator thereof can analyze still images taken by the robot(s) and can determine where the outer boundaries of a given tile reside.

FIG. 4 is a diagram illustrating exemplary methodology 400 for concurrent localization and heat/air flow/airborne matter mapping in a building having industry standard rectilinear tiles, such as a data center. Methodology 400 represents one exemplary manner in which step 302 of FIG. 3 and/or step 602 of FIG. 6 described below (simultaneous localization and heat/air flow/airborne matter mapping) may be carried out.

Methodology 400 will be described in the context of an energy and/or environmental leak detection system, such as system 100 described in conjunction with the description of FIG. 1, above, having one or more mobile robots configured to take temperature, air flow and/or airborne matter measurements throughout the data center. However, the steps of methodology 400 are broadly applicable to the localization and mapping of any type of mobile robot measurement system in the context of a data center, or any “regularly-tiled” space (for example a space tiled with rectangles, hexagons, or any known-to-be-repeating set of geometric shapes).

As will be apparent from the following description, the system can utilize recognition of the boundaries of industry standard rectilinear tiles to accurately generate a floor plan previously unknown to it. To begin the process, in step 402, the robot is placed on an unoccupied tile (i.e., an empty tile with nothing on it). This first or initial tile t1 can be any unoccupied tile on the building floor. For ease of description, reference is being made here to a single robot with the understanding that the steps provided herein could be followed in an analogous manner if multiple robots were to be employed.

As highlighted above, the computer (i.e., computer 106) can control the movements of the robot(s). Thus, one or more of the steps of methodology 400 can be performed by the computer, as indicated specifically below.

In step 404, a position of the robot relative to a center of the, e.g., initial, tile is determined. According to an exemplary embodiment, this is accomplished using a vision component. By way of example only, the vision component, as described above, can include a camera mounted to the robot that can take still pictures, or images. Based on those images and a position and angle of the tile boundary within the field of view, the system can be configured to determine the positioning of the robot relative to the center of the tile. For example, if the robot is positioned in the center of a tile facing precisely in the direction of an adjacent tile (i.e., towards the adjacent tile's center) then the tile boundary between the tile in which the robot is currently situated and the adjacent tile will appear as a horizontal line segment. The angle made with respect to the horizontal can be used to determine the robot's orientation using basic trigonometry. Also, the position of the tile boundary relative to the top of the field of view can be used to determine the position of the robot relative to the center of the current tile. According to an exemplary embodiment, the camera is positioned to always see exactly one and a half tiles directly in front of where the robot is currently positioned. Thus the further forward the nearest tile boundary is in the field of view, the further back must the robot be in the current tile. If the boundary is two-thirds up in the field of view then the robot is exactly crossing the tile boundary one tile back

According to an exemplary embodiment, the system leverages existing location-awareness technology employing one or more of on-board sonar, laser and video, employing the methods of Simultaneous Localization and Mapping (SLAM). See, for example, Durrant-Whyte to automatically discover the building/facility layout and its own relative position, and ensure that the entire layout is simultaneously traversed and mapped. The heart of the SLAM process is to use the environment to update the position of the robot. Since the odometry of the robot, which can be used to give an estimate of a position of the robot, generally accumulates error or a “drift” over time, it cannot be solely relied upon to obtain the position of the robot. In addition to odometry, laser, sonar and/or video can be used to correct the position of the robot. This is accomplished using Extended Kalman Filters (see. for example, Durrant-Whyte) to extract features of the environment and then re-observing these features as the robot moves around. In the SLAM literature, features are generally called “landmarks.” The Extended Kalman Filter keeps track of an estimate of the uncertainty in the position of the robot as well as uncertainty in the landmarks it has seen in the environment. The case of a robot navigation using a web-cam and navigating around a data center (or other building/facility) equipment guided by tile boundaries is just a special case of the more generic SLAM framework.

In step 406, the robot then moves itself to the center of the tile using the positioning information garnered in step 404 (i.e., from the vision component) to steer itself in the right direction and to move the appropriate distance. As noted above, based on the position and angle of the leading edge of the next tile, the robot will know its position relative to the tile center and its angular bearing (in other words, the angle the robot would make with the tile boundary if the robot were to continue moving straight forward). With this information and knowledge of a rate of speed, turning rate and radius of the robot (as obtained from its odometry), the robot can make progressively finer and finer grained corrections to its position relative to the center of the current tile until the robot reaches a position that the robot deems to be an adequate approximation of the center.

Once the robot has moved to the center of the tile, in step 408 the system directs the robot to take temperature, air flow and/or airborne matter measurements. In the first iteration of methodology 400, these readings will be taken from the center of the initial tile t1. Subsequent readings will be taken from the centers of tiles t2, t3, etc. (see below). According to an exemplary embodiment, a signal sent from the computer to the robot directs the robot to take the temperature, air flow and/or airborne matter measurement readings using the respective temperature, air flow and/or airborne matter sensors.

In step 409, the readings taken in step 408 are stored by the system along with the time and location (particular tile identification) at which they were taken. Each tile is uniquely identifiable by its x- and y-coordinates in tile units based on the dimensions of the tiles (or equivalently, in two foot increments).

Once readings are taken at a particular location, e.g., at t1, the robot moves to the next location, e.g., t2. The movement of the robot to the next location is coordinated as follows. In step 410, the robot rotates itself 90 degrees relative to its current (zero degree) position. This new position will be referred to herein as the 90 degree position. In step 412, the vision component is used to obtain an image of the tile that is adjacent to the current tile and at which the robot is now facing (in the 90 degree position). In step 414, the robot again rotates itself 90 degrees relative to the 90 degree position. The robot is now in what will be referred to herein as the 180 degree position. In step 416, the vision component is again used to obtain an image of the tile that is adjacent to the current tile and at which the robot is now facing (in the 180 degree position). In step 418, the robot rotates itself 90 degrees relative to the 180 degree position. The robot is now in what will be referred to herein as the 270 degree position. In step 420, the vision component is again used to obtain an image of the tile that is adjacent to the current tile and at which the robot is now facing (in the 270 degree position). In step 422, the robot rotates itself 90 degrees relative to the 270 degree position, back to the zero degree position.

In step 424, the system then analyzes the image data obtained by the robot (via the vision component) at the 90, 180 and 270 degree (orthogonal) positions, to determine if one or more of the adjacent tiles at those positions are unoccupied. For those tiles, that are determined to be unoccupied in step 424, the system in step 426 then determines whether or not the robot has already visited any of those tiles (and taken readings there), based for example on the tile ID (see step 409). In some directions the robot may already know whether or not the tile is vacant/occupied. For tiles of which the state is already known, one or more of the preliminary exploration steps (steps 410-422) may not need to be performed (e.g., the robot may just look in the 90 degree and 270 degree positions if the robot already knows what lies in the 0 and 180 degree positions (or because those tiles have already been visited). Of those adjacent tiles that are both unoccupied and have not been previously visited, in step 428, the robot then selects one of these tiles and moves to it. The selection of the tile, assuming multiple options are available, can be based for example on any conventional exploration methodology known to those of skill in the art. It is also not strictly necessary to examine all neighboring tiles to the current tile. In some cases the robot will know that a square is either occupied or not occupied based on its prior investigations, so the square need not be re-scanned. Furthermore, efficient exploration methodologies exist, and are known to those of skill in the art, such that the robot immediately moves to the first vacant square the robot encounters without identifying all neighboring vacant squares.

Steps 404-428 can be repeated until all unoccupied tiles in the building have been visited and readings taken, or the robot reaches a dead-end, where, from the current tile the robot can visit only previously visited tiles, but the building has not been completely visited. In this latter case, the robot must back up until it detects a tile with unvisited neighbor tiles. The robot then follows this path to the end following steps 404-428, again until the robot reaches a dead end. Finally the robot will back up to the very first tile and have no new tiles to visit. In this case, under the assumption that all tiles are visitable from the given initial tile, the robot will have seen all tiles. In case there are several disconnected “islands” of visitable tiles (tiles which are surrounded by unvisitable tiles), the robot will have to be transported (i.e., carried by a person) to a tile in the next island to continue its exploration and mapping. Note that, if at any point during the scan the robot runs low on battery power, the robot can return to its charging station, recharge and then resume the scan at the last location (tile visited).

The robot (or collection of collaborating robots) allocate their exploration time based on areas which are seen to have, or demonstrate the greatest likelihood for, temperature or flow variation, or matter fluxes—in other words the areas that are most likely to be candidates for energy and environmental leaks. For example, energy leaks in buildings typically occur along walls/windows/doors or other boundaries with the external environment. If a wall, door or room is discovered to be purely internal, that wall, door or room need not be further explored.

If the energy and/or environmental leak detection system is being used in a building that is not a naturally gridded space (i.e., the space is not tiled like a data center), simultaneous localization and mapping may be achieved by superimposing a transient grid on the space being explored, for example by “spray-painting” a grid of artificial rectilinear tiles using a short-lived alpha or beta emitter, and then detecting the presence or absence of the alpha or beta emissions in subsequent traversals. Any standard alpha or beta emitter may be employed, for example americium (the alpha emitter found in smoke detectors) or tritium (the beta emitter most commonly used in glow-in-the-dark road signs). These emitters can be dropped or sprayed through a slit by the robot when the odometry of the robot indicates that the robot has traversed a distance of one tile unit since the last virtual tile boundary was marked. Once a complete virtual tile (or even just two parallel edges) has (have) been laid down the robot can turn around by 45 degrees or 180 degrees to scan for additional tile lines and see how good a job has been done, successively correcting the lines as necessary. Since there may be many obstacles, in some situations it may only be possible for the robot to lay out a partial grid.

The proposed invention can also leverage mobile ad-hoc networking to coordinate multiple collaborating autonomic robots that collect independent monitoring information with different time and location stamps. According to the present teachings, a methodology is proposed based on the idea of onion-peeling that enables the integrated operation of two robots that work together (collaborate) to gather layout and sensor data in approximately half the time of a single robot. FIGS. 5A-B illustrate the methodology. The methodology works as follows: two robots, e.g., robots A and B, are initially placed in adjacent tiles on the boundary of the building (e.g., data center), as shown in FIG. 5A. The boundary of the building, as described above, are the walls, windows, doors or combination thereof that separate the interior of the building from the outside environment. The robots then move in opposite directions around the boundary until they again meet. See FIG. 5A. The movement of the robots from tile to tile was described in detail above. In this way the robots determine the first “layer of the onion,” i.e., the layer of tiles adjacent to the boundary. Next the robots A and B together step inward by one tile, and proceed in the same way again (see FIG. 5B). The robots will successively peel off additional layers, but in the process, because of the presence of obstacles, the robots will sometimes have to backtrack before meeting. This onion peeling methodology is best suited to the use of two robots. To more readily employ more than two robots, one simple approach is to try to decompose the bounding polygon of the space into subpolygons and dispatch the robots individually or in pairs to explore and map out the subpolygons. By way of example only, when the robots are used in pairs to explore and map the subpolygons, the onion peeling methodology, as described above, can be employed for each subpolygon. An additional method of coordinating the operation of multiple robots is for each robot to start from independent locations and perform independent, but coordinated, depth first searches, sharing each other's knowledge of visited, unvisted but unoccupied, and unvisited and occupied squares to accelerate the independent searches.

FIG. 6 is a diagram illustrating exemplary methodology 600 for detecting environmental leaks of airborne matter (as opposed to energy) in a building. Methodology 600 will be described in the context of an environmental leak detection system, such as system 100 (which, as described above, may optionally be an energy leak detection system as well) described in conjunction with the description of FIG. 1, above, having one or more mobile robots configured to take measurements of one or more types of airborne matter, throughout the building.

Each step of methodology 600 can be performed by a computer (for example computer 106 of FIG. 1, described above). The computer, as highlighted above, can be a centralized unit of the system and/or localized on-board the robot(s). Thus, with regard to the description of methodology 600, reference is made generically to actions performed by the system with the understanding that these actions can be performed by a centralized computer and/or by a computer(s) localized on-board the robot(s).

In step 602, the environmental leak detection system is used to map out a space, i.e., within the building, and concurrently take measurements of one or more types of airborne matter as well as time and positioning data. As described above, the airborne matter may include airborne particulate (solid) matter, airborne gaseous matter and/or airborne liquid matter (e.g., humidity). As also described above, the airborne matter constituents may be undesirable (for example in the case of a contaminant such as radon gas) or desirable and potentially intentionally produced (such as moisture to achieve a desired humidity). If a map is already available, e.g., from the steps of methodology 300 having been performed previously, then the map does not have to be regenerated, and the known map of the space can be used. With regard to time, an assumption is made that the airborne matter measurements gathered in one sampling run by the robot(s) are sufficiently close in time to be considered concurrent.

The space is generally the building or a part thereof. According to an exemplary embodiment, the space referred to herein is a space proximate to a boundary to the outside environment. By way of example only, the space could be the interior area of the building proximate to the boundary of the building (i.e., walls, doors and/or windows that separate the interior of the building from the outside environment). See, for example, FIGS. 5A-B (described above), wherein the one or two layers of tiles shown may be considered the interior area of the building proximate to the boundary. An exemplary methodology for “mapping out” a space and taking airborne matter measurements using the present environmental leak detection system with one or more mobile robots was described, for example, in conjunction with the description of FIG. 4, above. The term “map out,” as used herein, broadly refers to building/creating a map of the space simultaneously with the coordinated movement of the robot(s) from one location in the space to another (using for example a given grid or a superimposed grid to aid in navigation based on Simultaneous Localization and Mapping (SLAM) techniques). In this manner, the map can be built expeditiously.

In step 604, the measurements of the one or more types of airborne matter collected at each location (from the mapping and measurement performed in step 602) are used to create a transport (flow) model for this matter within the space, which is capable of providing an estimate of the concentration and flow of the matter at all points (even those for which direct measurements were not taken). According to an exemplary embodiment, the model created in this step is based upon the mapping and measurement data of step 602 plus knowledge of the physical process of dispersion—the tendency of airborne matter to “spread out” or move from areas of high concentration to areas of lower concentration. Techniques that can be used to create such a model would be apparent to one of skill in the art and thus are not described further herein. According to another exemplary embodiment, measurements of the airborne matter (from step 602) are supplemented with air flow measurements, and the model computed in this step is based upon the mapping and measurement data of step 602 (which include the air flow measurements) plus knowledge of the physical processes of both dispersion and advection. Advection refers to the tendency of the airborne matter to follow the overall flow pattern of the air, as would, for example have been captured in the steps outlined in step 304 of methodology 300 (described above). Techniques that can be used to create such a model would be apparent to one of skill in the art and thus are not described further herein. See, for example, P. K. Kitanidis, “Particle-tracking equations for the solution of the advection-dispersion equation with variable coefficients,” Water Resources Research, 30(11): 3225-3227 (November, 1994).

In step 606, the transport (flow) model for the airborne matter is used to identify locations in the building where significant fluxes (i.e., influxes or outfluxes) of the airborne matter exist. As described above, the airborne matter constituents may be undesirable (for example in the case of contaminant such as radon gas) or desirable and potentially intentionally produced (such as moisture to achieve a desired humidity).

In step 608, the extent of all such fluxes are quantified. In cases where influxes and outfluxes are with respect to the outside environment this computation may be performed, i.e., by summing over the fluxes across all boundary regions to the outside environment and using estimated influxes/outfluxes as identified in the model from step 604 in case regions were not directly measured by the robot or robots.

It is noted, however, that the source(s) of airborne matter may be present in the building, or other indoor environment, in which case the flux across one or more specified interior boundaries would be quantified. For example, to locate approximately the source of airborne matter, a set of natural closed boundaries (such as room boundaries) selected from the region in which the airborne matter density is highest could be chosen. These boundaries could correspond to physically identifiable boundaries such as the room boundaries noted above or could correspond to virtual boundaries used for computational purposes only. The source of the airborne matter would be identified as lying within the boundary for which the flux is greatest.

In step 610, the system characterizes the severity and type of the various leak sources. This may be done with reference to a database of previously seen or previously known leaks for the given type of airborne matter. For example, if the given airborne matter being detected is radon, the system can then appeal to known published guidelines for establishing the severity of the associated detected leak based on concentrations of radon daughter products found.

As shown in FIG. 6, steps 602-610 can be repeated. By way of example only, if a single scan of the building (representing for example one point in time) is desired, then steps 602-610 would be performed once and a quantitative assessment of airborne matter leaks in the building can be performed (see description of step 612, below). If, however, multiple scans of the building are desired, for example, to be performed at several different times throughout the year, then steps 602-610 could be repeated for example at a given time interval (such as once a month). Then, once data has been collected for a desired time period, e.g., for 6 months or a year, the quantitative assessment of airborne matter leaks in the building can be performed.

Having performed either a single scan, or several periodic scans over the course of a representative time interval, in step 612, the system aggregates its single point or points in time, in-building measurements and associated airborne matter flux estimates as described above to provide a quantitative assessment of the flux of the airborne matter constituents of concern in the building for that moment or those moments in time. As described, for example, in conjunction with the description of step 306 of FIG. 3 above, the space can be partitioned into a set of non-overlapping regions of equal volume and boundary surface area. That description is incorporated by reference herein. For a given scan, the airborne matter flux per region are summed for all of the regions to come up with a total flux for each airborne matter constituent at that moment or those moments.

In step 614, the data collected by the system from a single scan, or from multiple scans, can optionally be combined with information about seasonal temperature distributions, which influences overall airflow, to extend the airborne matter flux analysis over an extended period of time, e.g., over the course of a year. By way of example only, the scan data can be combined with data from a yearly weather model for a given locale (e.g., the city/town in which the building is located) and then the quantitative assessment (of step 614) can be performed using this combined data. In this example, the result will be an estimate of the airborne matter flux for the building over the period of a year.

Turning now to FIG. 7, a block diagram is shown of an apparatus 700 for implementing one or more of the methodologies presented herein. By way of example only, apparatus 700 can be configured to implement one or more of the steps of methodology 300 of FIG. 3 for detecting energy leaks in a building, in conjunction with an energy leak detection system, such as system 100 of FIG. 1 (which, as described above, may optionally be an environmental leak detection system as well). Apparatus 700 can also be configured to implement one or more of the steps of methodology 600 of FIG. 6 for detecting environmental leaks in a building, in conjunction with an environmental leak detection system, such as system 100 of FIG. 1 (which, as described above, may optionally be an energy leak detection system as well). As highlighted above, system 100 can include a computer(s) (e.g., computer 106) which can be central to the system, or (multiple computers) one on-board each of the mobile robots. Apparatus 700 can be configured to serve as computer 106 in system 100.

Apparatus 700 comprises a computer system 710 and removable media 750. Computer system 710 comprises a processor device 720, a network interface 725, a memory 730, a media interface 735 and an optional display 740. Network interface 725 allows computer system 710 to connect to a network, while media interface 735 allows computer system 710 to interact with media, such as a hard drive or removable media 750.

As is known in the art, the methods and apparatus discussed herein may be distributed as an article of manufacture that itself comprises a machine-readable medium containing one or more programs which when executed implement embodiments of the present invention. For instance, when apparatus 700 is configured to implement one or more of the steps of methodology 300 the machine-readable medium may contain a program configured to obtain temperature and air flow measurements from one or more mobile robots configured to move throughout at least a portion of the building and to take the temperature and air flow measurements at a plurality of locations within the building; create a temperature and air flow model of the building using the temperature and air flow measurements; and use the model to identify energy leaks in the building. When apparatus 700 is configured to implement one or more of the steps of methodology 700 the machine-readable medium may contain a program configured to obtain airborne matter measurements from one or more mobile robots configured to move throughout at least a portion of the building and to take the airborne matter measurements at a plurality of locations within the building; create a transport model of the airborne matter in the building using airborne matter measurements; and use the model to identify locations within building where there are significant influxes or outfluxes of airborne constituents.

The machine-readable medium may be a recordable medium (e.g., floppy disks, hard drive, optical disks such as removable media 750, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 720 can be configured to implement the methods, steps, and functions disclosed herein. The memory 730 could be distributed or local and the processor device 720 could be distributed or singular. The memory 730 could be implemented as an electrical, magnetic or optical memory, or any combination of these or other types of storage devices. Moreover, the term “memory” should be construed broadly enough to encompass any information able to be read from, or written to, an address in the addressable space accessed by processor device 720. With this definition, information on a network, accessible through network interface 725, is still within memory 730 because the processor device 720 can retrieve the information from the network. It should be noted that each distributed processor that makes up processor device 720 generally contains its own addressable memory space. It should also be noted that some or all of computer system 710 can be incorporated into an application-specific or general-use integrated circuit.

Optional video display 740 is any type of video display suitable for interacting with a human user of apparatus 700. Generally, video display 740 is a computer monitor or other similar video display.

Although illustrative embodiments of the present invention have been described herein, it is to be understood that the invention is not limited to those precise embodiments, and that various other changes and modifications may be made by one skilled in the art without departing from the scope of the invention. The contents of each of the references mentioned above are hereby incorporated by reference herein.

What is claimed is:

1. An energy leak detection system, comprising:
one or more mobile robots configured to move throughout at least a portion of a building and to take temperature and air flow measurements at a plurality of locations within the building.

2. The system of claim 1, further comprising a computer in communication with the one or more robots configured to receive temperature and air flow measurement and location data from the one or more robots.

3. The system of claim 1, wherein movements of the one or more robots are self-guided.

4. The system of claim 2, wherein the computer is configured to send location data to the one or more robots, and wherein movements of the one or more robots are guided by the computer.

5. The system of claim 1, comprising a plurality of collaborating robots.

6. The system of claim 1, wherein each of the one or more robots comprises:
one or more temperature sensors configured to take the temperature measurements.

7. The system of claim 6, wherein each of the one or more robots comprises a mast to which the one or more temperature sensors are attached.

8. The system of claim 7, wherein the mast is an automated telescoping mast.

9. The system of claim 1, wherein each of the one or more robots comprises:
one or more air flow sensors configured to take the air flow measurements.

10. The system of claim 9, wherein each of the one or more robots comprises a mast to which the one or more air flow sensors are attached.

11. The system of claim 10, wherein the mast is an automated telescoping mast.

12. The system of claim 1, wherein each of the one or more robots comprises:
one or more air contaminant sensors configured to take air contaminant measurements.

13. The system of claim 2, wherein the computer is configured to communicate with the one or more robots via a wireless connection.

14. The system of claim 1, wherein the one or more robots are configured to store temperature and air flow measurement and location data.

15. A method for detecting energy leaks in a building, comprising the steps of:
obtaining temperature and air flow measurements from one or more mobile robots configured to move throughout at least a portion of the building and to take the temperature and air flow measurements at a plurality of locations within the building;
creating a temperature and air flow model of the building using the temperature and air flow measurements; and
using the model to identify energy leaks in the building.

16. The method of claim 15, further comprising the step of:
determining a severity of each of the energy leaks identified.

17. The method of claim 15, further comprising the step of:
characterizing each of the energy leaks by its source.

18. The method of claim 15, further comprising the step of:
repeating the obtaining, creating and using steps at a given time interval.

19. The method of claim 15, further comprising the step of:
providing a quantitative assessment of the energy leaks in the building.

20. An apparatus for detecting energy leaks in a building, the apparatus comprising:
a memory; and
at least one processor device, coupled to the memory, operative to:
obtain temperature and air flow measurements from one or more mobile robots configured to move throughout at least a portion of the building and to take the temperature and air flow measurements at a plurality of locations within the building;
create a temperature and air flow model of the building using the temperature and air flow measurements; and
use the model to identify energy leaks in the building.

21. An environmental leak detection system, comprising:
one or more mobile robots configured to move throughout at least a portion of a building and to take airborne matter measurements at a plurality of locations within the building.

22. The system of claim 21, wherein the airborne matter measurements are taken of one or more of airborne particulate matter, airborne gaseous matter and airborne liquid matter.

23. The system of claim 22, wherein the airborne liquid matter comprises humidity.

24. The system of claim 22, further comprising a computer in communication with the one or more robots configured to receive airborne matter measurement and location data from the one or more robots.

25. The system of claim 22, wherein each of the one or more robots comprises:
one or more airborne matter sensors configured to take the airborne matter measurements.
